(19) United States
(12) Patent Application Publication
(10) Pub. No.: US 2026/0063777 A1
(43) Pub. Date: Mar. 5, 2026

(54) METHOD FOR CALIBRATING AN ULTRASONIC SENSOR OF AN ULTRASOUND-BASED DRIVER ASSISTANCE SYSTEM OF A VEHICLE AND VEHICLE

(71) Applicant: Robert Bosch GmbH, Stuttgart (DE)

(72) Inventors: Gergo Hodos, Korntal-Muenchingen (DE); Albert Meszaros, Stuttgart (DE); Michael Schumann, Stuttgart (DE); Timo Pfeiffer, Backnang (DE)

(21) Appl. No.: 19/308,641

(22) Filed: Aug. 25, 2025

(30) Foreign Application Priority Data
Aug. 28, 2024 (DE) 10 2024 208 186.8

(51) Int. Cl. G01S 7/52; G01S 15/931

(52) U.S. Cl. CPC G01S 7/52004; G01S 15/931

(57) ABSTRACT

A method for calibrating an ultrasonic sensor of an ultrasound-based driver assistance system of a vehicle. The vehicle is placed on a ground. The method includes: a) prespecifying a height of the ultrasonic sensor from the ground or ascertaining the height of the ultrasonic sensor from the ground; b) emitting a number of ultrasonic pulses, wherein each ultrasonic pulse is emitted to form a main lobe and a side lobe, and the emission takes place such that the side lobe is directed toward the ground; c) detecting a plurality of side-lobe ground echoes; d) ascertaining and storing a correction value for detecting an elevation angle with the ultrasonic sensor and/or ascertaining and storing a correction value for detecting an azimuth angle with the ultrasonic sensor based on a number of the plurality of side-lobe ground echoes detected in step c).

### FIELD

The present invention relates to a method for calibrating an ultrasonic sensor of an ultrasound-based driver assistance system of a vehicle and to a vehicle.

### BACKGROUND INFORMATION

Vehicles often have ultrasound-based driver assistance systems, in particular in the form of ultrasound-based parking aids, having several, for example 4 or 8, ultrasonic sensors, which are arranged on the vehicle to form a line of ultrasonic sensors.

A typical ultrasonic sensor of an ultrasound-based parking aid emits an ultrasonic pulse, which is reflected by an entity as an echo. The echo can be detected by the ultrasonic sensor, and a distance between the ultrasonic sensor and the entity can be ascertained on the basis of a duration of a time period between emitting the ultrasonic pulse and receiving the echo. In addition, the ultrasonic sensor can detect the incoming elevation angle and azimuth angle of the echo, which allows the position of the entity to be ascertained precisely.

### SUMMARY

An object of the present invention is to provide a method for calibrating an ultrasonic sensor of an ultrasound-based driver assistance system of a vehicle which makes it possible to calibrate the ultrasonic sensor with a high degree of accuracy.

An object of the present invention is also to provide a vehicle which is designed to carry out the method.

An object of the present invention may be achieved by a method and by a vehicle having certain features of the present invention. Advantageous developments of the present invention are disclosed herein.

A method according to the present invention is used for calibrating an ultrasonic sensor of an ultrasound-based driver assistance system of a vehicle. The vehicle is placed on a ground. According to an example embodiment of the present invention, the method comprises the following steps: a) prespecifying a height, in particular an installation height, of the ultrasonic sensor from the ground or ascertaining the height of the ultrasonic sensor from the ground; b) emitting a number, for example 1 to 50, of ultrasonic pulses, wherein each ultrasonic pulse is emitted to form a main lobe and a side lobe and the emission takes place such that each side lobe is directed toward the ground; c) detecting a plurality, for example 5 to 100, of side-lobe ground echoes with the ultrasonic sensor; and d) ascertaining and storing a correction value for detecting an elevation angle with the ultrasonic sensor and/or ascertaining and storing a correction value for detecting an azimuth angle with the ultrasonic sensor on the basis of a number, in particular all, of the plurality of side-lobe ground echoes detected in step c).

Advantageously, by using the side lobe for calibrating the ultrasonic sensor, a particularly precise calibration of the ultrasonic sensor can be achieved. In particular, the side lobe may have a smaller width than the main lobe, for which reason the side lobe strikes the ground in a narrow region and is reflected as a side-lobe ground echo. Consequently, detected side-lobe ground echoes that do not come from the narrow region can be excluded. This allows erroneous measurements to be reliably identified and excluded, making a more precise calibration possible.

Another aspect of the method of the present invention may be that side lobes have hitherto been considered disruptive, for which reason different strategies have typically been developed to avoid, in particular suppress, side lobes. In contrast, side lobes are generated when the method is executed and are used for calibration.

Another aspect of the method of the present invention may be that the use of side-lobe ground echoes for calibrating the ultrasonic sensor is particularly cost-effective and achieves a particularly high level of accuracy.

A further aspect of the method of the present invention may be that the method can be carried out while the vehicle is in use, for example during a parking maneuver.

The ultrasonic sensor can be calibrated by storing the correction values. After the calibration, elevation angles and/or azimuth angles of further echoes can be detected by means of the ultrasonic sensors particularly precisely by using the correction values.

The ground can be flat. The ground cannot have a step. The ground cannot be inclined relative to a longitudinal axis of the vehicle. Preferably, the ground can run parallel to the longitudinal axis of the vehicle.

A side-lobe ground echo can be understood as a portion of the ultrasound pulse reflected from the ground and which forms the side lobe. The side lobe can be reflected from the ground at a reflection point and propagate as a side-lobe ground echo.

Each side-lobe ground echo can strike the ultrasonic sensor at an elevation angle, wherein the elevation angle has a value in a range of 65° to 75°, in particular 70° to 72°.

According to an example embodiment of the present invention, ascertaining the height of the ultrasonic sensor from the ground in step a) may comprise emitting an ultrasonic pulse toward the ground at a maximum elevation angle of the ultrasonic sensor and receiving a ground echo, wherein the height of the ultrasonic sensor from the ground is ascertained on the basis of a measured duration of the time period between the emission of the ultrasonic pulse and the receiving of the ground echo.

According to an example embodiment of the present invention, the emission of the number of ultrasonic pulses in step b) can be carried out by means of the ultrasonic sensor.

The emission in step b) may be such that each main lobe is directed away from the ground.

According to an example embodiment of the present invention, the method may comprise the following steps: f) detecting a temperature during the execution of at least one of steps b) and c) ; and g) storing the temperature detected in step f).

The correction value ascertained in step d) for detecting the elevation angle and/or the correction value ascertained for detecting the azimuth angle may be temperature-dependent.

The ultrasonic sensor can have a detection range of 180°. As a result, the ultrasonic sensor can detect echoes of which the elevation angle and/or azimuth angle have a value in a range of +90° to −90°.

According to an example embodiment of the present invention, the method may comprise the step of checking the correction value for detecting the elevation angle and checking the correction value for detecting the azimuth angle. The check can be carried out by means of a reference object that is placed in front of the sensor at a defined angle.

According to an example embodiment of the present invention, after carrying out the method, the ultrasonic sensor can detect an elevation angle and/or an azimuth angle of an echo, wherein the detected elevation angle is corrected by the correction value ascertained in step d) for detecting the elevation angle and/or the detected azimuth angle is corrected by the correction value ascertained in step d) for detecting the azimuth angle.

In a development of the method of the present invention, detecting the plurality of side-lobe ground echoes in step c) comprises measuring an amplitude of the side-lobe ground echo for each side-lobe ground echo. The correction value for detecting the elevation angle and/or the correction value for detecting the azimuth angle of step d) is ascertained on the basis of the amplitudes of the side-lobe ground echoes measured in step c). This advantageously allows artifacts to be masked out. Furthermore, this ensures a high signal-to-noise ratio.

For example, according to an example embodiment of the present invention, the method may comprise, before step d), the step of: h) ascertaining, in particular selecting, the side-lobe ground echoes of which the amplitude measured in step c) is greater than a prespecified amplitude limit value. The correction value for detecting the elevation angle with the ultrasonic sensor and/or the correction value for detecting the azimuth angle with the ultrasonic sensor of step d) can be ascertained and stored on the basis of the side-lobe ground echoes ascertained in step h). The remaining side-lobe ground echoes can be masked out. Masking out a side-lobe ground echo can be understood as meaning that the masked-out side-lobe ground echo is not taken into account in ascertaining the correction values of step d).

In a development of the method of the present invention, the detection of the plurality of side-lobe ground echoes in step c) comprises, for each side-lobe ground echo, measuring an elevation angle of the side-lobe ground echo and/or an azimuth angle of the side-lobe ground echo and measuring a duration of a time period between emitting the ultrasonic pulse generating the side-lobe ground echo and receiving the side-lobe ground echo with the ultrasonic sensor. The correction value for detection of the elevation angle in step d) is ascertained on the basis of the elevation angles measured in step c) and the measured durations. Additionally or alternatively, the correction value for detecting the azimuth angle in step d) is ascertained on the basis of the azimuth angles measured in step c) and the measured durations. Advantageously, this makes it particularly easy to calibrate the ultrasonic sensor.

For example, the duration can be used to calculate a distance between the ultrasonic sensor and a reflection point on the ground. The reflection point can be a point on the ground from which the side lobe is reflected. The side-lobe ground echo can propagate from the reflection point. The correction value for detecting the elevation angle and/or the correction value for detecting the azimuth angle of step d) can be ascertained on the basis of the calculated distance.

In a development of the method of the present invention, the method comprises, before step d), the step of: e) ascertaining, in particular selecting, the measured elevation angles and/or azimuth angles of the side-lobe ground echoes of which the duration measured in step c) represents, in particular corresponds to or describes, a distance between the ultrasonic sensor and the ground which falls within a prespecified distance value range. The correction value for detecting the elevation angle and/or the correction value for detecting the azimuth angle in step d) is ascertained on the basis of the elevation angles and/or azimuth angles ascertained, in particular selected, in step e).

Advantageously, by limiting the side-lobe ground echoes in step e), ground requirements for successful calibration can be reduced. In particular, a region of the ground from which the side-lobe ground echoes used for calibration come can be reduced in size. Only the region of the ground from which the side-lobe ground echoes used for calibration come can meet the ground requirements for successful calibration. For example, the method can successfully calibrate the ultrasonic sensor even if only the region of the ground from which the side-lobe ground echoes used for calibration come is flat.

In a development of the method of the present invention, the correction value for detecting the elevation angle and/or the correction value for detecting the azimuth angle is ascertained in step d) on the basis of the measured elevation angle and/or azimuth angle of the side-lobe ground echoes of which the elevation angle falls within a prespecified elevation angle value range and/or of which the azimuth angle falls within a prespecified azimuth angle value range. Advantageously, outliers that are outside the prespecified elevation angle value range and/or azimuth angle value range can thus be masked out. This also makes it possible to mask out incorrect measurements that occur, for example, due to interference. Interference can occur, for example, due to small objects, potholes or interference from other ultrasonic sensors.

In a development of the method of the present invention, ascertaining the correction value for detecting the elevation angle in step d) comprises calculating an elevation median value and calculating an elevation standard deviation on the basis of a number of the measured elevation angles. Additionally or alternatively, ascertaining the correction value for detecting the azimuth angle in step d) comprises calculating an azimuth median value and calculating an azimuth standard deviation on the basis of a number of the measured azimuth angles.

The elevation median value and elevation standard deviation can be calculated for a given number, for example 30 or 50, of side-lobe ground echoes. Additionally or alternatively, the elevation median value and elevation standard deviation can be calculated for a given travel distance or time interval. The azimuth median value and azimuth standard deviation can be calculated for a given number, for example 30 or 50, of side-lobe ground echoes. Additionally or alternatively, the azimuth median value and azimuth standard deviation can be calculated for a given travel distance or time interval.

According to an example embodiment of the present invention, in step d), an elevation product can be stored as a correction value for detecting the elevation angle and/or an azimuth product can be stored as a correction value for detecting the azimuth angle. The elevation product can be calculated by multiplying the elevation median value by a prespecified elevation weighting factor. The azimuth product can be calculated by multiplying the azimuth median value by a prespecified azimuth weighting factor.

The elevation weighting factor may have a value in a range from −1 to +1, preferably from +0.3 to +0.7. The azimuth weighting factor may have a value in a range from −1 to +1, preferably from +0.3 to +0.7.

The elevation weighting factor and/or the azimuth weighting factor can be a negative value. As a result, the correction value for detecting the elevation angle can have a sign that is inverted, in particular reversed, with respect to the elevation median value and/or the correction value for detecting the azimuth angle can have a sign that is inverted, in particular reversed, with respect to the azimuth median value. This allows the correction of a measured elevation angle and/or azimuth angle to be carried out by means of an addition.

In a development of the method of the present invention, the method comprises, before step d), the step of: calculating an elevation difference and/or an azimuth difference for each side-lobe ground echo ascertained in step e). Each elevation difference is calculated by subtracting the measured elevation angle from a prespecified target elevation angle. Each azimuth difference is calculated by subtracting the measured azimuth angle from a prespecified target azimuth angle. The elevation median value is a median value of the elevation differences and the elevation standard deviation is a standard deviation of the elevation differences. The azimuth median value is a median value of the azimuth differences and the azimuth standard deviation is a standard deviation of the azimuth differences. Advantageously, this makes it possible to achieve particularly simple ascertainment of the correction value for detecting the elevation angle and/or particularly simple ascertainment of the correction value for detecting the azimuth angle.

In a development of the method of the present invention, in step d) the elevation median value, preferably with an inverted, in particular reversed, sign, is stored as a correction value for detecting the elevation angle. Additionally or alternatively, in step d) the azimuth median value, preferably with an inverted, in particular reversed, sign, is stored as a correction value for detecting the azimuth angle. For example, the elevation median value may have a positive value that is stored as a negative value as a correction value for detecting the elevation angle.

In a development of the method of the present invention, in step d) the correction value for detecting the elevation angle is stored if the elevation standard deviation is smaller than a prespecified maximum elevation standard deviation. Additionally or alternatively, in step d) the correction value for detecting the azimuth angle is stored if the azimuth standard deviation is smaller than a prespecified maximum azimuth standard deviation.

Advantageously, this can prevent an incorrect correction value for detecting the elevation angle and/or an incorrect correction value for detecting the azimuth angle from being stored. If the elevation standard deviation is greater than or equal to the prespecified maximum elevation standard deviation, at least steps b) and c) can be performed again. If the azimuth standard deviation is greater than or equal to the prespecified maximum azimuth standard deviation, at least steps b) and c) can be performed again.

A vehicle according to the present invention, in particular a motor vehicle, comprises an ultrasound-based driver assistance system, which is designed to carry out a method described above.

The ultrasound-based driver assistance system can take the form of an ultrasound-based parking aid.

The ultrasound-based driver assistance system can comprise a control device which is designed to carry out the method described above.

Possible exemplary embodiments of the present invention will be explained below with reference to the figures.

### BRIEF DESCRIPTION OF THE DRAWINGS

FIG. 1 is a schematic plan view of a vehicle with an ultrasound-based driver assistance system, according to an example embodiment of the present invention.

FIG. 2 is a schematic side view of the vehicle in FIG. 1, according to an example embodiment of the present invention.

FIG. 3 is a further schematic side view of the vehicle in FIG. 1, according to an example embodiment of the present invention.

FIG. 4 is a schematic rear view of the vehicle in FIG. 1, according to an example embodiment of the present invention.

FIG. 5 is a schematic plan view of an ultrasonic sensor of the ultrasound-based driver assistance system in FIG. 1, according to an example embodiment of the present invention.

### DETAILED DESCRIPTION OF EXAMPLE EMBODIMENTS

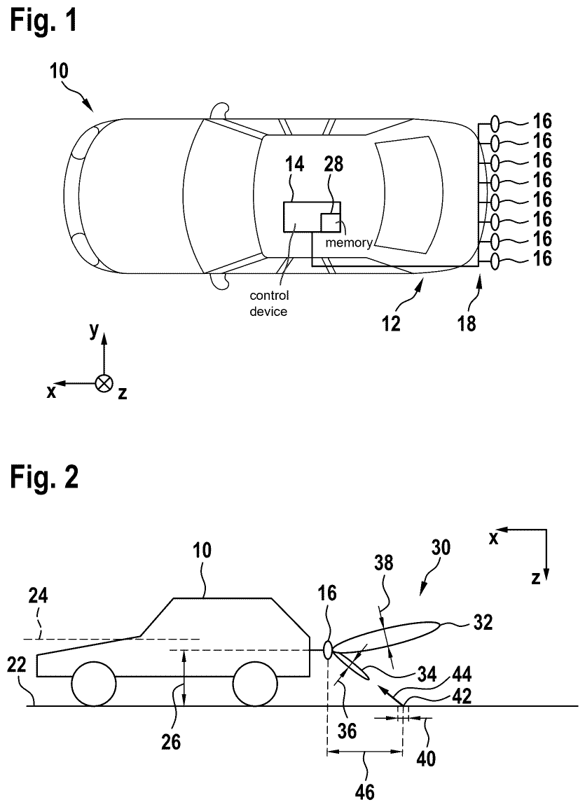

FIG. 1 shows a vehicle 10 with an ultrasound-based driver assistance system 12. The ultrasound-based driver assistance system 12 has a control device 14 and eight ultrasonic sensors 16. The ultrasonic sensors 16 are connected to the control device 14 with regard to signaling.

The ultrasound-based driver assistance system 12 is in the form of an ultrasound-based parking aid. The ultrasonic sensors 16 are arranged at a rear of the vehicle 10. The ultrasonic sensors 16 can be arranged in a line of ultrasonic sensors 18.

The ultrasound-based driver assistance system 12 is designed to carry out a method for calibrating an ultrasonic sensor 16 of the line of ultrasonic sensors 18. In particular, the ultrasonic sensors 16 are calibrated one after the other by means of the method.

FIG. 2 shows the vehicle 10 with one ultrasonic sensor 16 from the line of ultrasonic sensors 18 in an x/z-plane framed by a longitudinal direction and a vertical direction of the vehicle 10. In the following, the calibration of the ultrasonic sensor 16 shown in FIG. 2 using the method is described by way of example. The remaining ultrasonic sensors 16 can be calibrated accordingly.

The vehicle 10 is placed on a ground 22. The ground 22 is flat. The ground 22 runs parallel to a longitudinal axis 24 of the vehicle 10.

The ultrasonic sensor 16 is spaced apart from the ground 22 by a height 26. The height 26 can be referred to as the installation height. A value of the height 26 is stored in a memory 28 of the control device 14.

In an alternative exemplary embodiment not shown, the control device ascertains the height of the ultrasonic sensor from the ground. For this purpose, the control device can control the ultrasonic sensor in such a way that it emits an ultrasonic pulse at a maximum evolution angle in the direction of the ground. The control device may ascertain the height of the ultrasonic sensor from the ground on the basis of a measured duration of the time period between emitting the ultrasonic pulse and receiving, by the ultrasonic sensor, a ground echo from the ultrasonic pulse that has the shortest duration of all received ground echoes.

FIG. 2 shows that the ultrasonic sensor 16 is designed to emit an ultrasonic pulse 30.

The ultrasonic sensor 16 emits a number, for example 1 to 50, of ultrasonic pulses 30. The ultrasonic sensor 16 emits the ultrasonic pulses 30 in such a way that each ultrasonic pulse 30 forms a main lobe 32 and a side lobe 34. The side lobe 34 is directed toward the ground 22. The main lobe 32 is not directed toward the ground 22. In other words, the main lobe 32 is directed away from the ground 22.

The side lobe 34 has a width 36. The main lobe 32 has a width 38. A width 36 of the side lobe 34 is less than a width 38 of the main lobe 32. As a result, the side lobe 34 strikes the ground 22 in a relatively narrow region 40.

The portion of an ultrasonic pulse 30 forming the side lobe 34 strikes the ground 22 and is reflected from the ground 22 as a side-lobe ground echo 44. The portion of a single ultrasonic pulse 30 forming the side lobe 34 may be reflected from the ground 22 at a single or at multiple reflection points 42, thereby generating a single or multiple side-lobe ground echoes 44. The reflection point 42 is at a reflection point distance 46 from the ultrasonic sensor 16.

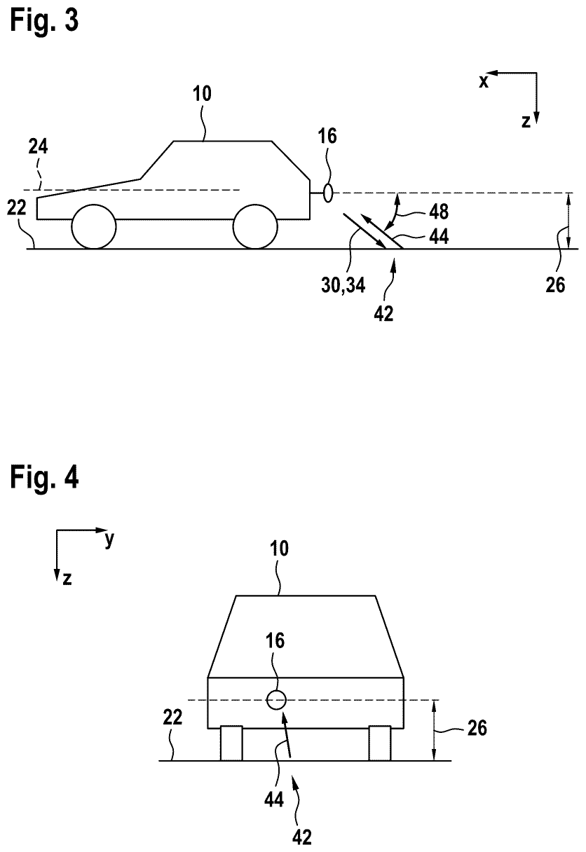

FIG. 3 shows the vehicle 10 in a further side view corresponding to FIG. 2, wherein the main lobe 32 and the side lobe 34 of the ultrasonic pulse 30 are not shown for reasons of clarity. FIG. 3 shows that the side-lobe ground echo 44 strikes the ultrasonic sensor 16 at an elevation angle 48.

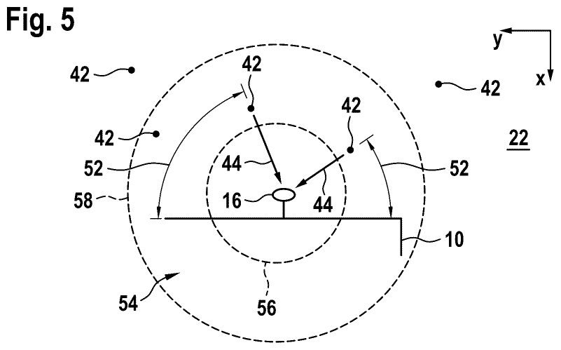

FIG. 4 shows the vehicle 10 in FIG. 1 to 3 in a rear view, wherein for reasons of clarity only the ultrasonic sensor 16 shown in FIG. 2 is shown and the other ultrasonic sensors 16 are hidden. The side-lobe ground echo 44 strikes the ultrasonic sensor 16 at an azimuth angle 52, see FIG. 5.

The ultrasonic sensor 16 is designed to detect the side-lobe ground echoes 44 of the number of ultrasonic pulses 30. The detection of the side-lobe ground echoes 44 comprises, for each side-lobe ground echo 44, measuring an amplitude of the side-lobe ground echo 44, measuring the elevation angle 48 of the side-lobe ground echo 44, measuring the azimuth angle 52 of the side-lobe ground echo 44, and measuring the duration of a time period between emitting the ultrasonic pulse 30 that generates the side-lobe ground echo 44 and detecting the side-lobe ground echo 44 with the ultrasonic sensor 16. In addition, the ultrasonic sensor 16 detects a temperature when a side-lobe ground echo 44 is detected.

The control device 14 ascertains, in particular selects, the side-lobe ground echoes 44 of which the measured amplitude is greater than a prespecified amplitude limit value. The remaining side-lobe ground echoes 44 are masked out. Masked-out side-lobe ground echoes 44 are no longer taken into account after having been masked out.

FIG. 5 is a schematic plan view of the ultrasonic sensor 16. The control device 14 ascertains, in particular selects, the side-lobe ground echoes 44 of which the reflection point 42 is located within a prespecified distance value range 54.

For this purpose, the control device 14 calculates a distance between the ultrasonic sensor 16 and the reflection point 42 from the duration of the time period between emitting the ultrasonic pulse 30 and detecting the side-lobe ground echo 44. On the basis of the prespecified height 26 of the ultrasonic sensor 16 and the calculated distance between the ultrasonic sensor 16 and the reflection point 42, the control device 14 calculates the distance 46 of the reflection point 42. The control device 14 compares the distance 46 to determine whether it is greater than a prespecified lower limit value 56 and smaller than a prespecified upper limit value 58. The prespecified distance value range 54 is limited by the lower limit value 56 and the upper limit value 58.

The remaining side-lobe ground echoes 44, the reflection points 42 of which are outside the prespecified distance value range 54, are masked out.

The control device 14 calculates an elevation difference for each ascertained side-lobe ground echo 44 by subtracting the measured elevation angle 48 from a prespecified target elevation angle. The target elevation angle can, for example, be 71°. The control device 14 calculates an azimuth difference for each ascertained side-lobe ground echo 44 by subtracting the measured azimuth angle 52 from a prespecified target azimuth angle. The target azimuth angle can, for example, be 90°.

The control device 14 ascertains the side-lobe ground echoes 44 of which the evaluation difference lies within a prespecified value range and/or of which the azimuth difference lies within a prespecified value range. The remaining side-lobe ground echoes 44 are masked out. This advantageously allows outliers or incorrect measurements to be masked out.

The control device 14 calculates an elevation median value and an elevation standard deviation for the elevation differences of the ascertained side-lobe ground echoes 44 that have not yet been masked out. The control device 14 calculates an azimuth median value and an azimuth standard deviation for the azimuth differences of the ascertained side-lobe ground echoes 44 that have not yet been masked out. The elevation median value and the elevation standard deviation can be calculated, for example, when the ascertained number of side-lobe ground echoes 44 is greater than or equal to a prespecified value, for example 30 or 50. The azimuth median value and the azimuth standard deviation can be calculated, for example, when the ascertained number of side-lobe ground echoes 44 is greater than or equal to a prespecified value, for example 30 or 50.

The control device 14 compares the value of the elevation standard deviation with a value of a prespecified maximum elevation standard deviation. If the value of the elevation standard deviation is greater than the value of the prespecified maximum elevation standard deviation, the control device 14 aborts the elevation angle calibration method. In the shown exemplary embodiment, the value of the elevation standard deviation is less than the value of the prespecified maximum elevation standard deviation, which is why ascertaining the correction value for detecting the elevation angle 48 is continued.

The control device 14 compares the value of the azimuth standard deviation with a value of a prespecified maximum azimuth standard deviation. If the value of the azimuth standard deviation is greater than the value of the prespecified maximum azimuth standard deviation, the control device 14 aborts the azimuth angle calibration method. In the shown exemplary embodiment, the value of the azimuth standard deviation is less than the value of the prespecified maximum azimuth standard deviation, which is why ascertaining the correction value for detecting the azimuth angle 52 is continued.

The control device 14 calculates an elevation temperature mean value on the basis of the measured temperatures detected during the detection of the side-lobe ground echoes 44, which are used to calculate the elevation median value and the elevation standard deviation. The control device 14 calculates an azimuth temperature mean value on the basis of the measured temperatures detected during the detection of the side-lobe ground echoes 44, which are used to calculate the azimuth median value and the azimuth standard deviation.

The control device 14 calculates an elevation product by multiplying the elevation median value by a prespecified elevation weighting factor. The elevation weighting factor may have a value in a range from −1 to +1, preferably from +0.3 to +0.7. The control device 14 calculates an azimuth product by multiplying the azimuth median value by a prespecified azimuth weighting factor. The azimuth weighting factor may have a value in a range from −1 to +1, preferably from +0.3 to +0.7.

The control device 14 stores in the memory 28 and/or in a memory of the ultrasonic sensor 16 the elevation product as a correction value for detecting the elevation angle 48 with the ultrasonic sensor 16 and/or the azimuth product as a correction value for detecting the azimuth angle 52 with the ultrasonic sensor 16.

The control device 14 stores in the memory 28 and/or in a memory £ of the ultrasonic sensor 16 the elevation temperature mean value and/or the azimuth temperature mean value.

By storing the elevation product and/or the azimuth product, the calibration of the ultrasonic sensor 16 is completed.

The method is repeated for the remaining ultrasonic sensors 16 of the line of ultrasonic sensors 18.

After calibration, an echo can be detected with the ultrasonic sensor 16. The measured elevation angle and/or azimuth angle of the echo is corrected by the stored elevation product and/or the stored azimuth product. The correction can be carried out, for example, by forming a difference between the measured elevation angle and the stored evaluation product and/or by forming a difference between the measured azimuth angle and the stored azimuth product. This allows the elevation angle and/or the azimuth angle of the echo to be detected particularly precisely.

In an exemplary embodiment not shown, a correction value for detecting the elevation angle and a correction value for detecting the azimuth angle can be stored for different temperature ranges. This allows different correction values to be used for different temperature ranges. For example, a temperature can be measured during the detection of the elevation angle and/or the azimuth angle, and on the basis of the measured temperature, a correction value for detecting the elevation angle and/or a correction value for detecting the azimuth angle can be determined by which the measured elevation angle and/or azimuth angle is corrected.

1-10. (canceled)

11. A method for calibrating an ultrasonic sensor of an ultrasound-based driver assistance system of a vehicle, wherein the vehicle is placed on a ground, and wherein the method comprises the following steps:
a) prespecifying a height of the ultrasonic sensor from the ground or ascertaining the height of the ultrasonic sensor from the ground;
b) emitting a number of ultrasonic pulses, wherein each of the ultrasonic pulses is emitted to form a main lobe and a side lobe, and the emission is such that the side lobe is directed toward the ground;
c) detecting a plurality of side-lobe ground echoes; and
d) ascertaining and storing a correction value for detecting an elevation angle with the ultrasonic sensor and/or ascertaining and storing a correction value for detecting an azimuth angle with the ultrasonic sensor, based on a number of the plurality of side-lobe ground echoes detected in step c).

12. The method according to claim 11, wherein:
the detecting of the plurality of side-lobe ground echoes of step c) includes measuring an amplitude of the side-lobe ground echo for each side-lobe ground echo,
the correction value for detecting the elevation angle and/or the correction value for detecting the azimuth angle of step d) is ascertained based on the amplitudes of the side-lobe ground echoes measured in step c).

13. The method according to claim 11, wherein:
the detection of the plurality of side-lobe ground echoes of step c) includes, for each of the side-lobe ground echos, measuring an elevation angle of the side-lobe ground echo and/or an azimuth angle of the side-lobe ground echo, and measuring a duration of a time period between emitting the ultrasonic pulse that generates the side-lobe ground echo and receiving the side-lobe ground echo with the ultrasonic sensor, and
(i) the correction value for detecting the elevation angle of step d) is ascertained based on the elevation angles measured in step c) and the measured durations, and/or
(ii) the correction value for detecting the azimuth angle of step d) is ascertained based on the azimuth angles measured in step c) and the measured durations.

14. The method according to claim 13, wherein:
the method further comprises, performing before step d), a step e) selecting the measured elevation angles and/or azimuth angles of the side-lobe ground echoes (44) of which the duration measured in step c) represents a distance between the ultrasonic sensor and the ground which falls within a prespecified distance value range,
the correction value for detecting the elevation angle and/or the correction value for detecting the azimuth angle in step d) is ascertained based on the elevation angles and/or azimuth angles selected in step e).

15. The method according to claim 13, wherein in step d), the correction value for detecting the elevation angle and/or the correction value for detecting the azimuth angle, is ascertained based on the measured elevation angle and/or the measured azimuth angle of the side-lobe ground echoes of which the elevation angle falls within a prespecified elevation angle value range and/or of which the azimuth angle falls within a prespecified azimuth angle value range.

16. The method according to claim 13, wherein:
the ascertaining of the correction value for detecting the elevation angle in step d) includes calculating an elevation median value and calculating an elevation standard deviation based on a number of the measured elevation angles, and/or
the ascertaining of the correction value for detecting the azimuth angle in step d) includes calculating an azimuth median value and calculating an azimuth standard deviation based on a number of the measured azimuth angles.

17. The method according to claim 16, wherein:
the method further comprises, before step d), a step of: calculating an elevation difference and/or an azimuth difference for each side-lobe ground echo ascertained in step e),
each elevation difference is formed by subtracting the measured elevation angle from a prespecified target elevation angle,
azimuth difference is formed by subtracting the measured azimuth angle from a prespecified target azimuth angle,
the elevation median value is a median value of the elevation differences and the elevation standard deviation is a standard deviation of the elevation differences,
the azimuth median value is a median value of the azimuth differences and the azimuth standard deviation is a standard deviation of the azimuth differences.

18. The method according to claim 17, wherein:
in step d) the elevation median value, with an inverted sign, is stored as the correction value for detecting the elevation angle, and/or
in step d) the azimuth median value, with an inverted sign, is stored as the correction value for detecting the azimuth angle.

19. The method according to claim 16, wherein:
in step d) the correction value for detecting the elevation angle is stored when the elevation standard deviation is smaller than a prespecified maximum elevation standard deviation, and/or
in step d) the correction value for detecting the azimuth angle is stored when the azimuth standard deviation is smaller than a prespecified maximum azimuth standard deviation.

20. A motor vehicle, comprising:
an ultrasound-based driver assistance system including an ultrasonic sensor, the ultrasound-based driver assistance system configured to calibrate the ultrasonic sensor, wherein the motor vehicle is placed on a ground, and wherein the ultrasound-based driver assistance system is configured to:
a) prespecify a height of the ultrasonic sensor from the ground or ascertaining the height of the ultrasonic sensor from the ground,
b) emit a number of ultrasonic pulses, wherein each of the ultrasonic pulses is emitted to form a main lobe and a side lobe, and the emission is such that the side lobe is directed toward the ground,
c) detect a plurality of side-lobe ground echoes, and
d) ascertain and store a correction value for detecting an elevation angle with the ultrasonic sensor and/or ascertain and store a correction value for detecting an azimuth angle with the ultrasonic sensor, based on a number of the plurality of side-lobe ground echoes detected in step c).
